(19) United States
(12) Patent Application Publication
(10) Pub. No.: US 2024/0087083 A1
(43) Pub. Date: Mar. 14, 2024

(54) Scalable Cross-Modality Image Compression

(71) Applicant: City University of Hong Kong, Kowloon (HK)

(72) Inventors: Shiqi Wang, Kowloon (HK); Pingping Zhang, Kowloon (HK); Tak Wu Sam Kwong, Kowloon (HK)

(21) Appl. No.: 17/944,411

(22) Filed: Sep. 14, 2022

(51) Int. Cl. G06T 3/40; G06T 9/00; G06V 20/70

(52) U.S. Cl. CPC G06T 3/4046; G06T 9/002; G06V 20/70

(57) ABSTRACT

A computer-implemented method for scalable compression of a digital image. The method contains the steps of extracting from the image semantic information at a semantic layer, extracting from the image structure information at a structure layer, extracting from the image signal information at a signal layer; and compressing each one of the semantic information, the structure information, and the signal information into a bitstream. A novel scalable cross-modality image compression is therefore provided where a wide spectrum of novel functionalities have been enabled, making the codec versatile for applications ranging from semantic understanding to signal-level reconstruction.

### FIELD OF INVENTION

This invention relates to image and video compressions, and in particular to compressions based on deep-learning.

### BACKGROUND OF INVENTION

Image compression aims to compactly represent image signals to facilitate transmission and storage. Viewed in another way, a main objective of image compression is to maximize the ultimate utility of the reconstructed visual information, given a constrained number of used bits. A series of image compression standards have been developed in the past decades, such as the JPEG [46], the JPEG2000 [31], the High Efficiency Video Coding (HEVC)/H.265 [37], and the Versatile Video Coding (VVC)/H.266 [8]. Many of these image compression standards belong to scalable coding which enables input signals to be coded into embedded bitstream, such that the bitstream can be partially decoded for consequential reconstructions. There are many types of scalability, including spatial scalability, temporal scalability, and quality scalability [7, 34]. Most researchers mainly focus on the scalable compression with pixel fidelity [12]. Scalable compression has been proven to be an efficient representation method by encoding the visual signals into several layers. As such, the decoding of higher layers typically relies on the existence of lower layers [48]. In [47], it is shown that compact feature representation and visual signal compression can be naturally incorporated into a unified scalable coding framework, based upon the excellent reconstruction capability of deep generative models.

Recent years have witnessed the exciting development of machine learning technologies, which make fully data driven image compression solutions possible [4, 5, 18, 26]. Learning-based image compression has achieved remarkable compression performance improvement, revealing that neural networks are capable of non-linearly modeling visual signals to benefit compression efficiency [3, 18, 29]. As a result, researchers explored scalable schemes on learning-based compression, and most coding schemes are based on hierarchical representations [39, 40, 47, 55]. In particular, a typical autoencoder structure consists of convolutional and deconvolutional LSTM (long short-term memory) recurrent networks [39, 40], with which one single model could generate multiple compression rates. Wang et al. [47] designed a scalable coding framework based on decomposition of basic features and texture, in which a base layer serves as deep learning features and an enhancement layer targets to perfectly reconstruct the texture.

On the other hand, with the advance of computer vision, images which excel at conveying visual information, can be understood and perceived in a variety of ways. The semantic information, which is intrinsically critical in image understanding, plays an important role in the visual information representation. In particular, it enjoys several advantages, including being compact to represent, friendly to understand, as well as closely tied to visual signals. However, the semantic information has been unfortunately ignored in some current learning base image representation models, in particular when the end-to-end coding strategy converts the visual signals to the latent code without sufficient interpretability. Image data can be compactly represented to achieve semantic communication via semantic scalabilities [24, 38, 41]. Tu et al. [41] proposed an end-to-end semantic scalable image compression, which progressively compresses coarse-grained semantic features, fine-grained semantic features, and image signals. However, low bitrate coding scenarios may lead to non-negligible coding artifacts such as blurs. Sun et al. [38] proposed a learning-based semantically structured image coding framework, where each part of the bitstream represents a specific object and can be directly utilized in different tasks. This framework is mainly designed for machine analysis instead of human perception. Analogously, Liu et al. [24] proposed semantics-to-signal scalable compression, where partial bitstreams could convey information for machine analysis, and meanwhile complete bitstreams could be decoded to visual signals. These codecs typically represent images with a single modality, and it is still challenging to achieve a very compact representation with semantically meaningful information conveyed.

### SUMMARY OF INVENTION

Accordingly, the present invention, in one aspect, is a computer-implemented method for scalable compression of a digital image. The method contains the steps of extracting from the image semantic information at a semantic layer, extracting from the image structure information at a structure layer, extracting from the image signal information at a signal layer; and compressing each one of the semantic information, the structure information, and the signal information into a bitstream.

In some embodiments, the semantic information is included in a text caption. The step of extracting the semantic information further includes the step of generating the text caption of the image using image-to-text translation.

In some embodiments, the step of generating the text caption further includes the steps of translating the image into compact representations using a convolutional neural network (CNN), and using a recurrent neural network to generate the text caption from the compact representations.

In some embodiments, the step of compressing the semantic information further includes the step of conducting a lossless compression of the text caption.

In some embodiments, the step of compressing the signal information further includes compressing the signal information using a learning-based codec.

In some embodiments, the structure information includes a structure map. The step of extracting the structure information further includes a step of obtaining the structure map using Richer Convolutional Features (RCF) structure extraction.

According to another aspect of the invention, there is provided a computer-implemented method for reconstructing a digital image from multiple bitstreams including a semantic stream, a structure stream, and a signal stream. The method includes the steps of decoding, from the semantic stream, semantic information of the digital image; decoding, from the structure stream, structure information of the digital image; combining the structure information and the semantic information to obtain a perceptual reconstruction of the image; decoding, from the signal stream, signal information of the digital image; and reconstructing the image using the signal information based on the perceptual reconstruction.

In some embodiments, the semantic information is included in a text caption. The step of decoding the semantic information further includes generating a semantic image from the text caption.

In some embodiments, the semantic information contains a semantic texture map which is adapted to be used to extract semantic features, and the structure information includes a structure map which is adapted to be used to extract structures.

In some embodiments, the step of combining the structure information and the semantic information further includes aligning semantic features derived from the semantic texture map and structure features derived from the structure map, as well as fusing the aligned structure and semantic features.

In some embodiments, the step of aligning the structure and semantic features includes converting the structure map and the semantic texture map into feature domains, and aligning the structure and semantic features using a multi-scale alignment strategy.

In some embodiments, the step of fusing the multi-scale structure features with the signal features includes conducting self-calibrated convolution separately to the aligned structures and semantic features, and merging the aligned structure and semantic features via element-wise addition.

In some embodiments, the step of reconstructing the image includes generating multi-scale structure features from the structure map and the perceptual reconstruction; and fusing the multi-scale structure features with the signal features to reconstruct the image.

According to another aspect of the invention, there is provided a system for scalable compression of a digital image, the system comprising a non-transitory computer-readable medium with instructions stored thereon, that when executed by a processor, cause the processor to perform the encoding method as mentioned above.

According to another aspect of the invention, there is provided a system for scalable compression of a digital image, the system comprising a non-transitory computer-readable medium with instructions stored thereon, that when executed by a processor, cause the processor to perform the decoding method as mentioned above.

Embodiments of the invention therefore provide a scalable cross-modality compression (SCMC) scheme, in which the image compression is further cast into a representation problem by hierarchically sketching the image with different modalities. More specifically, a conceptual organization philosophy is provided to model the overwhelmingly complicated visual patterns, based upon the semantic, structure, and signal level representation accounting for different tasks. The scalable coding paradigm that incorporates the representation at different granularities supports diverse application scenarios, such as high-level semantic communication and low-level image reconstruction. The decoder, which enables the recovery of the visual information, benefits from the scalable coding based upon the semantic, structure, and signal layers. Qualitative and quantitative results demonstrate that the SCMC schemes according to the embodiments can convey accurate semantic and perceptual information of images at low bitrates, and promising rate-distortion performance has been achieved compared to state-of-the-art methods.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 shows the hierarchical structure of a SCMC scheme according to a first embodiment of the invention.

FIG. 2 illustrates the structure of a semantic layer in the SCMC scheme of FIG. 1.

FIG. 3 shows a pipeline framework of a structure layer in the SCMC scheme of FIG. 1.

FIG. 4a shows the framework of the self-calibrated convolution (SC) in the structure layer of FIG. 3.

FIG. 4b shows the framework of the fusion block in the structure layer of FIG. 3.

FIG. 5a shows the workflow of the encoder of FIG. 1 at the signal layer.

FIG. 5b shows the process of structure feature extraction at the signal layer of FIG. 5a.

FIG. 6 is a flowchart showing the process of scalable compression of an image using the SCMC scheme of FIG. 1.

FIG. 7 is a flowchart showing the process of decoding compressed bitstreams to reconstruct an image using the SCMC scheme of FIG. 1.

FIG. 8a shows a comparison chart of the R-D performance when LPIPS is used as a quality evaluation measure.

FIG. 8b shows a comparison chart of the R-D performance when DISTS is used as a quality evaluation measure.

FIG. 9 is an illustration of exemplary decoded mages from the three corresponding layers of the SCMC scheme in FIG. 1.

FIG. 10 shows exemplary decoded images using the SCMC scheme in FIG. 1 under ultra-low bitrate compression, as compared to a conventional image compression scheme VTM.

FIG. 11 shows exemplary decoded images and structure maps using the SCMC scheme in FIG. 1, as compared to VTM.

FIG. 12 shows exemplary decoded images using the SCMC scheme in FIG. 1, as compared to various conventional image compression schemes in terms of visual quality.

In the specification and drawings, like numerals indicate like parts throughout the several embodiments described herein.

### DETAILED DESCRIPTION

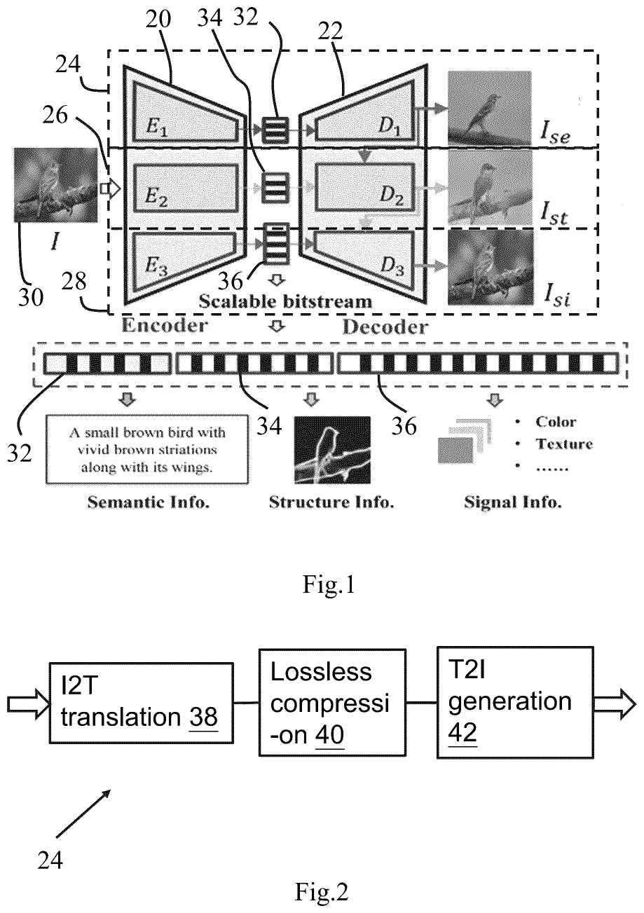

FIG. 1 is an illustration of a SCMC scheme according to one embodiment of the invention, in which one can see that the hierarchical organization of the SCMC is based upon three different levels of representations, namely semantic, structure and signal level representations. Specifically, an encoder 20 and a decoder 22 in the SCMC scheme each contain three layers, including a semantic layer 24 (including E₁ and D₁), a structure layer 26 (including E₂ and D₂) and a signal layer 28 (including E₃ and D₃). These three layers 24, 26, 28 work coherently and seamlessly in the SCMC scheme to support high-level semantic communication and low-level image reconstruction. The encoder 20 is adapted to separately extract semantic, structure, and signal level representations from an image data 30 via layered compression, yielding embedded bitstreams 32, 34, 36. More specifically, the semantic layer 24 is a base layer, which is configured to extract text captions from the image data 30 where the text captions include semantic information, and to compress the text captions into a semantic bitstream 32 with an ultra-low bitrate. The structure layer 26, as the second layer, is configured to extract structure information from the image data 30 which is further compressed with the VVC [1] into a structure bitstream 34. The signal layer 28 serves as the final layer, and is configured to compress signal representation as extracted from the image data 30 into a signal stream 36 based upon an existing learning-based codec [5].

In the decoder 22, the bitstreams 32, 34, 36 can be partially decoded to obtain visual reconstruction from semantic, structure and signal perspectives. In other words, while all three bitstreams 32, 34, 36 can be decoded to obtain a best image as reconstructed, it is possible to decode any one or two of the three bitstreams 32, 34, 36 to obtain a less optimal image reconstruction. In the decoder 22, the semantic layer 24 reconstructs the semantic information from compact text descriptions contained in the semantic bitstream 32. The structure layer 26 generates images by decompressing the semantic bitstream 32 and the structure bitstream 34, promoting a perceptual reconstruction of images. The image reconstruction at the signal layer 28 as the final level is intrinsically based upon the reconstructed images from the first two layers. The information from the previous layer serves as conditional information, such that the interaction strategy between the three layers 24, 26, 28, ensures that redundancy among the layers 24, 26, 28, can be efficiently removed, leading to scalable cross-modality image compression.

Next, the detailed structure of each of the layers 24, 26, 28 will be described, accompanied by their working principles in performing image encoding and image decoding. Turn to FIG. 2. Firstly, the semantic information extraction based upon image captioning lays the foundation for the semantic layer 24, which could be represented in an extremely compact way. As such, instead of extracting the semantic information at the receiver given the corrupted image, the semantic layer 24 allows the high quality reconstruction of the semantic information even at ultra-low bitrate. Thus, the heart of the semantic layer 24 lies in image-text-image (ITI) cross-modality translation, compression and representation. Cross-modality image representation is fundamentally benefited from the generative capability of neural networks as well as the advancements of vision plus language research. More specifically, the semantic layer 24 contains three submodules, including I2T translation 38, lossless compression 40 for text description, and T2I generation 42. The I2T translation 38 and lossless compression 40 are part of the encoder 20, and in particular part of the sub-module E₁ in FIG. 1. The T2I generation 42 is part of the decoder 22, and in particular part of the sub-module D₁ in FIG. 1.

In FIG. 2, the I2T translation 38 in the encoder 20 aims to compress image data from the signal domain into a compact text description. I2T, also known as image caption, which depicts the images as a syntactically and semantically meaningful sentence. This persuades the images to be represented in a compact, semantically meaningful, and human comprehensible form. For the I2T translation 38, an end-to-end neural network is used for this purpose which is capable of automatically generating a reasonable description in plain English [44]. This scheme utilizes a convolutional neural network (not shown) that translates the image into compact representations, followed by a recurrent neural network (not shown) that generates the corresponding description sentence. In comparison to the visual signals, the text domain is semantically meaningful and compact. This could be regarded as an alternative way to remove the redundancy, preserving the information that is only beneficial to the final utility if image understanding serves as the ultimate task. Exceptional performance is demonstrated by the I2T translation 38 as deep neural networks are applied via multimodal learning, the encoder-decoder framework, and attention-guided architecture. After the text captions that include the semantic information are extracted from the image data by I2T translation 38, statistical redundancy may still exist. As such, lossless compression 40 which is based on Huffman coding [19] is employed to remove statistical redundancy in text compression.

On the side of the decoder 22, the T2I generation 42, also known as image generation from the text, aims to synthesize fine-grained images from the text descriptions with semantic consistency. For this purpose, AttnGAN [50] is used in the T2I generation 42 to reconstruct images from the text descriptions. The images thus reconstructed are semantic images. AttnGAN incorporates an attention mechanism into the generator by pretraining a text processor and an image processor to extract position-sensitive features from a text stream and an image stream, respectively. The decoded semantic map can provide the semantic texture for the image reconstruction. Based upon the T2I generation 42, the visual signals with the same semantic information can be generated from the semantic layer 24, although the signal level reconstruction cannot be guaranteed.

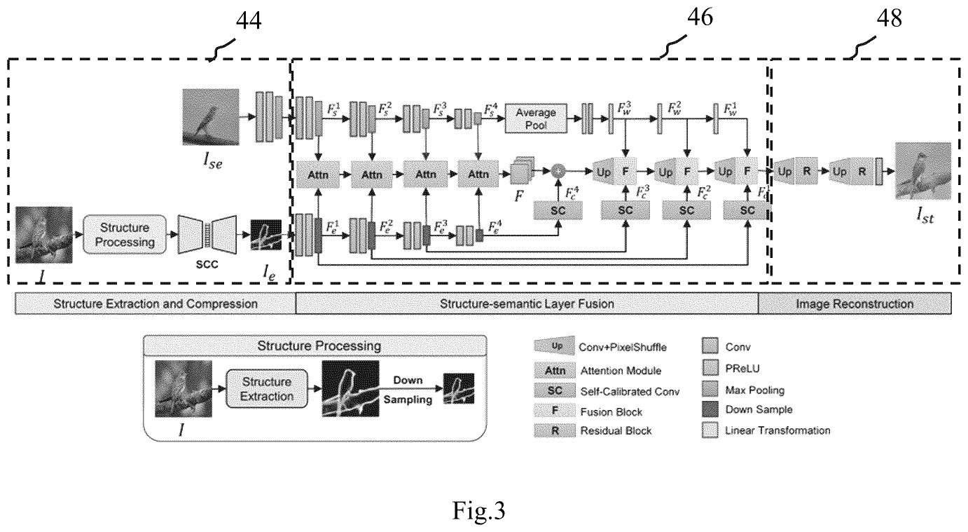

Next, the structure layer 26 will be described with details of its structure and working principle. Turn to FIG. 3, in which the pipeline framework of the structure layer 26 is illustrated. The structure layer 26 contains three submodules, including structure extraction and compression 44, structure-semantic layer fusion 46, and image reconstruction 48. The structure extraction and compression 44 is part of the encoder 20, and part of the sub-module E₂ in FIG. 1. The structure-semantic layer fusion 46 and image reconstruction 48 are part of the decoder 22, and part of the sub-module D₂ in FIG. 1.

Following the insight of Marr [28], geometric structures (e.g., edges and ridges) and stochastic textures are two prominent components composing the visual scene. As such, the structure extraction and compression 44 compresses the structure map of the image data 30 (i.e., input image I) into a bitstream with low bitrates and reconstruct the image Iₛₜ based on structures and semantic textures, as shown in FIG. 1 and FIG. 3. In the encoder 20, the structure information is extracted, and then compressed into the structure bitstream 34. In more details, in the encoder 20 the structural map of the input image I is obtained through the Richer Convolutional Features (RCF) structure extraction [25]. RCF can fully exploit multiscale and multilevel information of objects to encapsulate both semantic and fine detail features, such that structure extraction could be both accurate and efficient. More importantly, even though the structure map extracted via RCF is compressed with a high compression ratio, it is still able to maintain a good structure. To compactly represent the structural information, structure maps are firstly downsampled by a factor of two and the downsampled structural map is compressed via VTM with QP 50 under all intra (AI) configurations, wherein the screen content coding (SCC) tools [56] are enabled, due to the strong capability in compressing screen content images with sharp and abundant edges. In this way, the structure bitstream 34 of the structure maps can be obtained.

In the decoder 22, for the structure layer 26 a combined reconstruction scheme of geometric structures that are mentioned above, and semantic textures from the semantic layer 24, is used to improve representation capability. In particular, the reconstructed structure map Iₑ and semantic texture map Iₛₑ are combined to facilitate the generation of the reconstruction of this layer. The structure-semantic layer fusion 46 contains two stages, including aligning structure and semantic features, and fusing the aligned structure and semantic features. Due to information inconsistency between semantically generated texture from the semantic layer 24 and the reconstructed structure from the structure layer 26, the reconstructed structure map Iₑ and semantic texture map Iₛₑ are converted into feature domains to align them via a multi-scale alignment strategy. Specifically, the multi-scale features can be extracted from Iₛₑ and Iₑ, including (Fₛ¹Fₛ², Fₛ³, Fₛ⁴) and (Fₑ¹, Fₑ², Fₑ³, Fₑ⁴), respectively. An attention module [42] is employed to align the features, where it initially calculates weight maps reflecting the similarity (S=QK^{T}) between semantic texture features and structure features. Herein, Q represents the semantic features, and K denotes the structure features. Then the features can be calibrated through the similarity maps. With Max(S) operation, one can extract the most important pixel in the last dimension of S. These maps are marked as Sₘ, such that the attention operation ( [symbol] ) is as follows,

[symbol]

(Sₘ,S,V)=softmax(Sₘ−S)V (Eq.1)

where V represents the Fₑ¹ in the first attention module and the rest ones are the outputs of the previous attention modules. For Fₛⁱ and Fₑⁱ (i∈1,2,3,4), the attention module is utilized to align these features. Through the coarse-to-fine alignment, the aligned compact features F with the semantic information is progressively obtained.

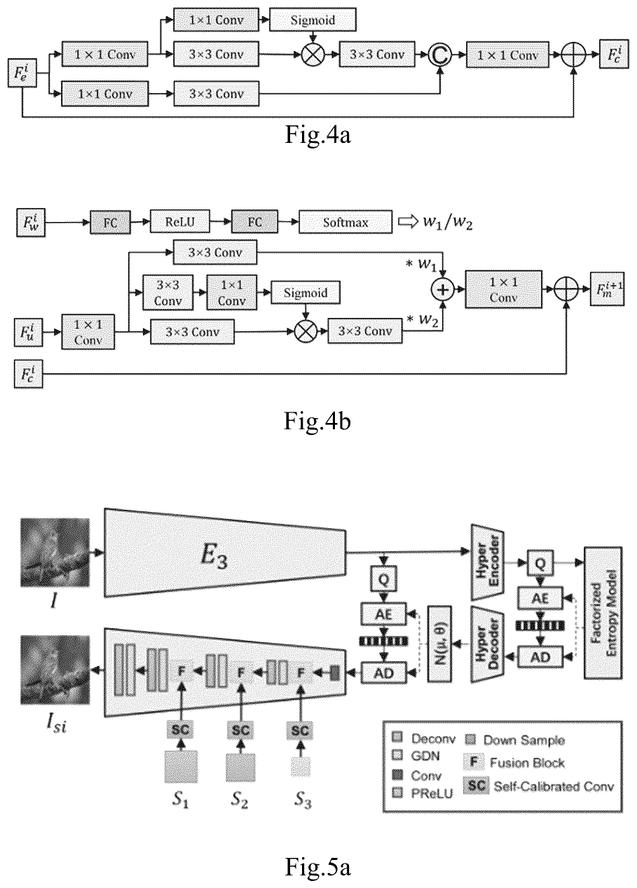

After aligning the structure and semantic features, structure features are merged into aligned features after self-calibrated convolution[23] via the element-wise addition, where self-calibrated convolution operation is shown in FIG. 4a. Then, an upsampling module, including a convolution operation and a Pixel Shuffle operation [36] are performed. Following feature upsampling, the spatial dimension is enlarged two times. For better reconstruction of the details, the semantic information and structure features are fused after adjusting them via self-calibrated convolution for further improvements. The fusion block is illustrated in FIG. 4b, where Fᵤⁱ is the output of the upsampling block. F_{c}ⁱ are structure features after the self-calibrated convolution, and F_{w}ⁱ a extracted from semantic features is utilized to adjust the aligned features. The index i belongs to {3, 2, 1}. Fᵤⁱ first conducts the self-calibrated convolution, of which the weights are extracted from semantic features. After self-calibrate convolution, the structure features perform the pixel-wise addition with aligned features to obtain fusion features (Fₘⁱ⁺¹) as the input of the next upsampling operation. Through hierarchical calibration and fusion, more accurate semantic texture and structure features can be obtained to contribute to image generation.

After a multi-scale fusion operation, the final reconstruction consists of two upsampling operations and two residual blocks, where the residual block is only composed of two convolution layers. Through them, an image with similar semantics and structure as the input image can be generated. To obtain perceptual reconstruction even at low bit rates, a loss function is designed to train the structure layer. The generator G generates the image on the condition of the semantic maps Iₛₑ and structure maps Iₑ. The discriminator is then trained to distinguish the generated image Iₛₜ=G(Iₛₑ, Iₑ) with the original image I. The network is trained with LSGANs [27] in an end-to-end manner as follows,

$${ℒ}_{d} ( G , D ) = \frac{1}{2} {𝔼}_{I \sim p ( I )} {‖ D ( I ) - 1 ‖}_{2}^{2} + \frac{1}{2} {𝔼}_{{I}_{se} \sim p ( {I}_{s e} ) , {I}_{e} \sim p ( {I}_{e} )} {‖ D ( G ( {I}_{se} , {I}_{e} ) ) ‖}_{2}^{2} . \qquad ( Eq \text{.2} )$$

In addition, the [symbol] ₂ loss is used between the generated image Iₛₜ and the input image I to preserve the pixel-wise texture information,

[symbol]

_{g}(G)= [symbol] _{I˜p(I),I}_{ₑ}_{˜p(I}_{ₑ}₎∥I−G(Iₛₑ, Iₑ)∥₂² (Eq.3)

where D is the discriminator and the detailed design follows the method in [29]. To maintain the semantic consistency and optimize visual quality, a new term is introduced, which is the DISTS [13] loss ( [symbol] _{DISTS}) to further enhance the connection between the inputted image (I) and the reconstructed image (Iₛₜ) for perceptual fidelity. With the enforcement of the [symbol] ₁ and [symbol] _{DISTS}, the intrinsic similarity between the input images and the generated images is largely improved, facilitating the conceptual representations for texture information.

[symbol]

ᵣₑ=λ₁ [symbol] ₁(I,Iₛₜ)+λ_{d} [symbol] _{DISTS}(I,Iₛₜ) (Eq.4)

As such, the objective function of the framework is

$${G}^{*} = arg {min}_{G} {max}_{D} {ℒ}_{d} ( G , D ) + {λ}_{g} {ℒ}_{g} ( G ) + {ℒ}_{re} \qquad ( Eq \text{.5} )$$

where λ_{g}, λ₁ and λ_{d} are the weighting parameters to balance each component, and it is empirically set that λ_{g}=1, λ₁=10 and λ_{d}=10.

After the end-to-end training, the structure layer 26 combined with the structure features extracts the texture information from semantic images to promote image generation.

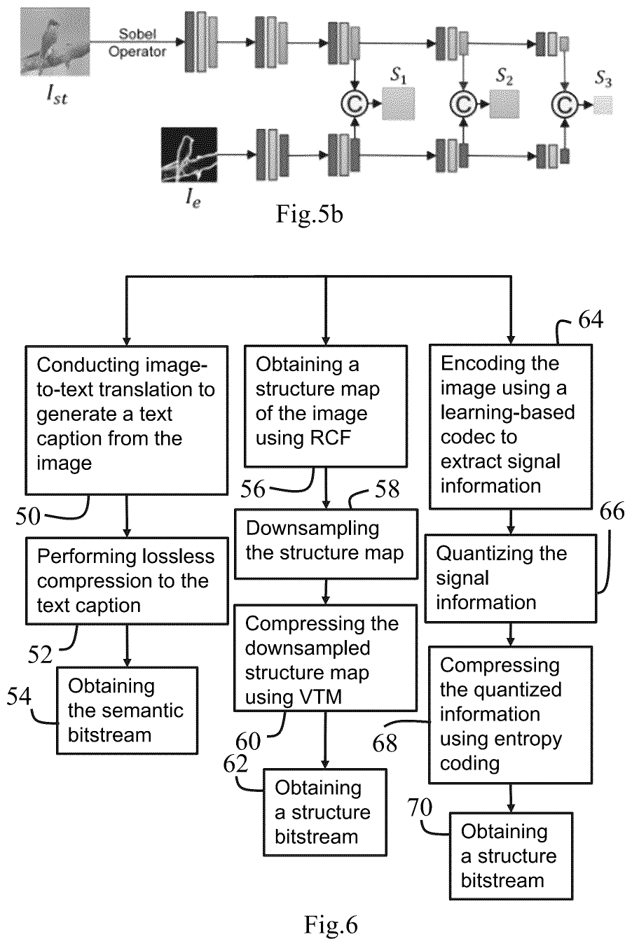

Next, the signal layer 28 will be described with details of its structure and working principle. Involving signal-level attributes (e.g., color and background) is conducive to reconstructing original image signals. In the signal layer 28, the focus is on compressing the signal-level information. More specifically, the signal-level information is delicately extracted from the input image I and compressed as the bitstream at the encoder-side, conveying signal-level characteristics. The decoder 22 parses the bitstream, generating the reconstructed image Iₛᵢ with the assistance of the associated structure information from the second layer. The framework is shown in FIGS. 5a and 5b, which is constructed based on an existing learning-based codec [5]. It contains the encoding module E₃, quantization (Q), entropy coding (AE/AD), and the decoding module D₃. The encoder module and entropy coding module share the identical backbone with the existing learning-based codec [5], showing the promising capability of image compression.

To obtain genuine signal representation, the decoder 22 is improved by involving the initial structure-level information in the image reconstruction during the decoding process. The multi-scale structure features serve as the conditional information in the decoder. More specifically, multi-scale structure features are extracted from the decoded structure maps Iₑ and the output of the structure layer Iₛₜ via the Sobel operator. These structure features provide the layout and detailed texture information to facilitate image reconstruction. Subsequently, these structure features readjust via self-calibrated convolution and fuse with signal features through the fusion operation, which is identical to the fusion block in the structure layer. In this manner, the conditional information from the previous layer can be fully utilized to promote signal compression performance.

The rate-distortion (RD) loss function ( [symbol] _{RD}) in this layer includes the content reconstruction distortion [symbol] ₘₛₑ and the bitrate (R) for the image encoding, which is given by

[symbol]

_{RD}=λ [symbol] ₘₛₑ+R (Eq.6)

where λ is the hyper-parameter to control the trade-off between the bitrate and distortion.

Having described the structures and working principles of the three layers 24, 26, 28, an encoding method for an image data 30 utilizing the SCMC scheme in FIGS. 1-5b is now described with reference to FIG. 6. The method includes separately extracting semantic, structure and signal information from the image data 30 and then compressing these information into respective bitstreams 32, 34 and 36. As shown in FIG. 1 and FIG. 6, the generations of the three bitstreams 32, 34 and 36 are independent and conducted in parallel to each other. However, those skilled in the art should realize that in variations of the preferred embodiment it is also possible to conduct the compressions of these information and generate the bitstreams in a sequential order.

For the semantic information, the method starts at Step 50 in FIG. 6 in which the image-to-text translation is conducted for the image data 30 which results in a text caption, an example of which is shown in FIG. 1 that includes the semantic information. Then, in Step 52 the text caption is compressed in a lossless way to remove statistical redundancy. After these two steps, the semantic bitstream 32 is obtained in Step 54. For the structure information, the method starts at Step 56 in which a structure map is extracted from the image data 30 using RCF. An example of the structure map is shown in FIG. 1 as structure information. Then, in Step 58 the structure map is firstly downsampled by a factor of two, and then in Step 60 the downsampled structural map is compressed via VTM with QP 50 under all intra (AI) configurations, wherein the SCC tools [56] are enabled. In the end, the structure bitstream 34 of the structure map can be obtained in Step 62. For the signal information, the method starts at Step 64 in which signal-level visual information is extracted from the image data 30 using the learning-based codec, Ballé et al. [5]. Examples of the signal-level visual information including color and texture are illustrated in FIG. 1. Then, in Step 66 the signal-level visual information is quantized to yield discrete-valued vectors. The discrete-valued vectors are then losslessly compressed in Step 68 using entropy coding methods such as arithmetic coding (Rissanen and Langdon, 1981). In the end, the structure bitstream 36 can be obtained in Step 70. By now, all three bitstreams 32, 34 and 36 are generated, which can be send over communication channels.

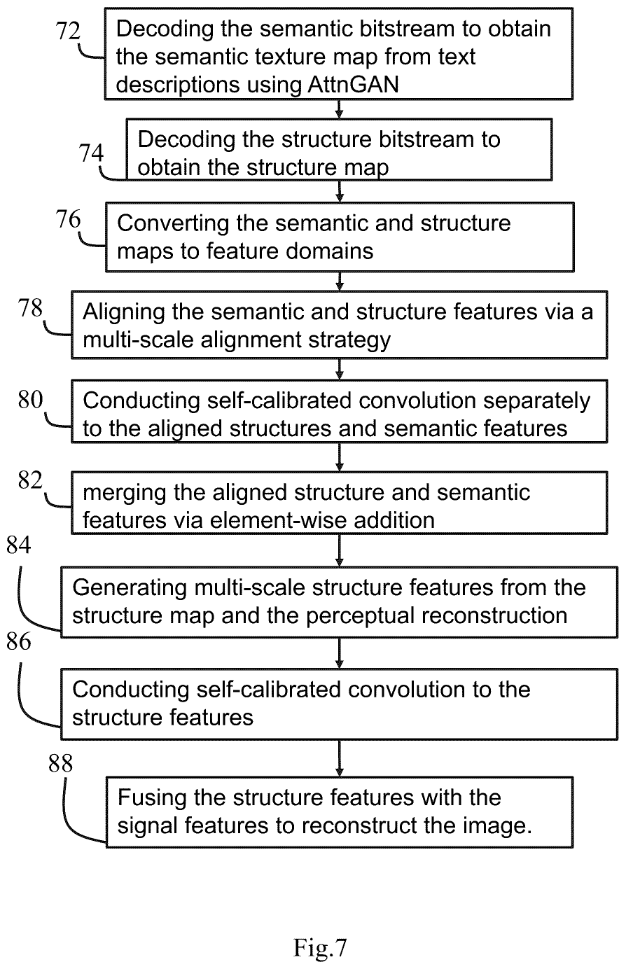

In FIG. 7, a method of reconstructing an image from the three bitstreams 32, 34 and 36 in FIG. 1 is illustrated. It should be noted that the method in FIG. 7 provides the best quality of reconstructed image since all three bitstreams 32, 34 and 36 are decoded and information contained therein are utilized. However, it should be understood that in some scenarios (e.g., when the bandwidth of communication is limited), then only one or two of the three bitstreams 32, 34 and 36 may be received by the decoder and decoded, resulting in a less-satisfactory reconstructed image. The method starts at Step 72, where the semantic bitstream 32 is decoded using AttnGAN to obtain a semantic texture map from the text descriptions. Then, in Step 74 the structure bitstream 34 is decoded to obtain a structure map. In Step 76, both the structure map and the semantic texture map obtained in previous steps are converted to feature domains. In Step 78, the semantic and structure features are aligned using a multi-scale alignment strategy. In Step 80, self-calibrated convolution is separately conducted for the aligned structures and semantic features. In Step 82, the aligned structure and semantic features are then merged via element-wise addition to obtain a perceptual reconstruction of image. In Step 84, multi-scale structure features are generated from the structure map and the perceptual reconstruction obtained in previous steps. In Step 86, the multi-scale structure features are applied with self-calibrated convolution. Finally, the structure features are fused with the signal features to reconstruct the image in Step 88.

In the following sections, an experiment setup for the SCMC scheme illustrated in FIGS. 1-5b will be described. For the experiment, CUB-200-2011 dataset [45] which includes 200 bird species is adopted. The dataset is divided into training and testing subsets. The training dataset includes 8,855 images with 160 bird species and the testing dataset contains 2,933 images with 40 bird species. Each image is associated with 10 descriptions. In the following experiments, the images are resized to 256×256.

Following the evaluation criterion in T2I tasks [21, 50], Inception Score (IS) [33] and Fréchet Inception Distance (FID) [17] are employed to evaluate model performance. In particular, IS measures the naturalness and the diversity of images, and FID estimates the distribution distance between the original input and the generated image. Hence, IS and FID are leveraged as quantitative measures to evaluate the performance of the semantic layer. Considering that PSNR could not well reflect the visual quality [13, 22, 54], LPIPS [54] and DISTS [13] are employed as the quality evaluation measures. In particular, LPIPS and DISTS are devised based on deep features [13, 22, 54], which exhibit excellent performance for both traditional and learning-based compression distortions [22]. In particulate, lower DISTS/LPIPS value indicates better quality. The coding bitrate is evaluated as the bits per pixel (bpp).

The network is implemented in the PyTorch framework and trained on NVIDIA GeForce RTX 3090 GPUs. Detailed information regarding the experimental settings of three layers are provided below. For the semantic layer, two training steps are taken, including training the I2T translation and the T2I generation. For the I2T translation, the batch size is set to 128 and the learning rate to 0.001 with 100 epochs. Images are randomly cropped to 224×224. Other settings follow those in [3]. For the T2I generation, the settings of AttnGAN [50] is followed. For the structure layer, the batch size is set to 16 and the learning rate to 0.0001 with 200 epochs. Moreover, regarding the compression of the structure maps, the VVC test model (VTM-15.2) [1] of screen content coding (SCC) is adopted under AI configuration, where the QP is set as 50. For the signal layer, the learning-based codec, Ballé et al. [5] is employed as the backbone. The batch size is set to 128 and the learning rate to 0.001 with 200 epochs. The λ is set as 5×2^{t}, where t is equal to {0, 2, 4, 6, 8}, corresponding to different bitrate points.

To verify the effectiveness of the SCMC scheme in the experiment setup, the outputs of three layers are shown in FIG. 9, and it is apparent that along with the increase of the coding bits, the fidelity of the reconstructed images can be significantly improved. Meanwhile, the following image compression schemes are involved for performance comparisons,
JPEG: a JPEG encoder is used with the quality factors QFs={1, 5, 10, 20, 30, 40}, corresponding to the compression ratios from large to small.
VVC (Intra): the VVC test model (VTM-15.2) is employed with quantization parameters QPs={63, 57, 52, 42, 37, 32, 27, 22}, and higher QP corresponds to lower bitrate.
Ballé et al.'s method [5]: the training and testing strategies follow those provided by CompressAI [6].

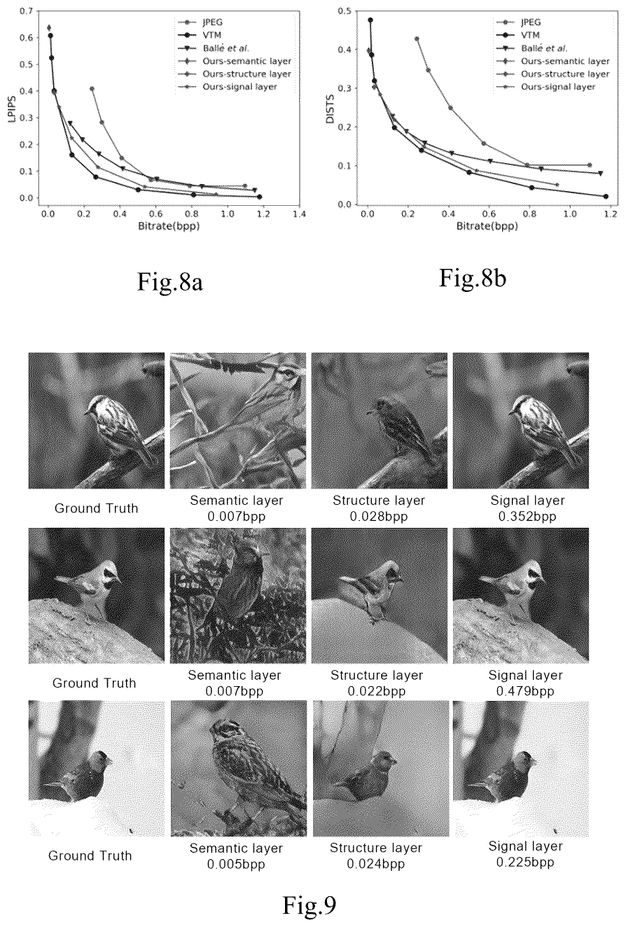

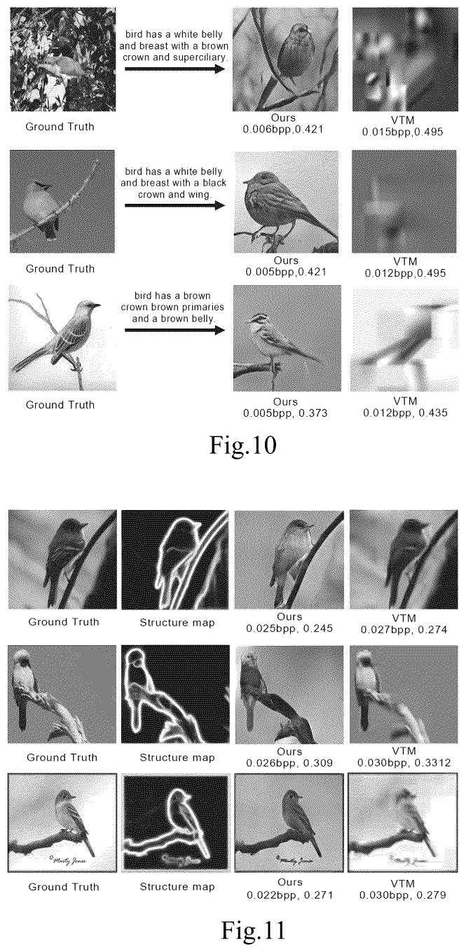

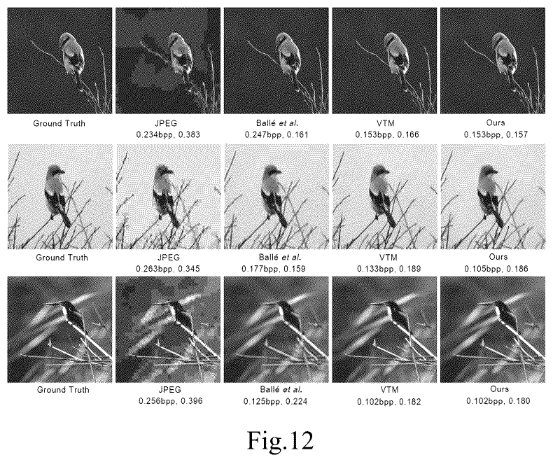

To evaluate the compression performance of the SCMC scheme configured n the experiment setup (hereinafter “proposed” or “our” method, approach, framework, model, layer, etc.) quantitatively, the proposed ITI is compared with the JPEG, VTM, and Ballé et al.'s methods. All the images in the testing set with different quality factors are compared. The Rate-Distortion (RD) performance comparisons are illustrated in FIGS. 8a-8b. Moreover, the visualization results of distinct layers are provided in FIG. 10, FIG. 11, and FIG. 12.

The semantic layer can achieve ultra-high compression ratios with semantically promising texture reconstructions. However, extremely low-bitrate compression is difficult to attain when employing JPEG and Ballé et al.'s framework. As shown in FIGS. 8a-8b, “Ours-semantic layer” denotes the R-D performance of the semantic layer in terms of the LPIPS and DISTS. It is easy to observe that the proposed method as shown in FIG. 1 has close performance with VTM at the ultra-low bitrate, whereas the proposed method outperforms VTM when evaluated with DISTS. Meanwhile, the quality of generated semantic images on FID and IS are evaluated and shown in Table 1 below. The proposed model with lower bitrate compression can still provide better FID and IS performance. Furthermore, the reconstructions of the proposed semantic layer and VTM are visualized to compare semantic information, as shown in FIG. 10. In FIG. 10, the first column is the ground truths, and the second column is the description of the image generated via the I2T translation. The third column shows the results of the T2I generation, and the last column is the results decompressed via VTM with QP=63. The bpp and DISTS values are shown under each image, where lower DISTS values indicate better quality. It can be seen that the text descriptions are semantically consistent with the raw images. Even though VTM may compress images at an ultra-low bitrate, the images are blurry, failing to convey semantic information. By contrast, the reconstructed images with the proposed scheme are sharp and fine-grained, sharing similar semantic information with the raw images.

TABLE 1
Quantitative results at the ultra-low bitrate

| | bpp | FID(↓) | IS(↑) |
|---|---|---|---|
| VTM-15.2 | 0.013 | 328.715 | 1.150 |
| Ours-Semantic layer | 0.005 | 52.258 | 2.260 |

The structure layer compresses image data with the assistance of the semantic texture and structure maps. The comparison results of the structure layer are shown in FIGS. 8a-8b, where “Ours-structure layer” illustrates the R-D performance of the structure layer in terms of the LPIPS and DISTS. The results indicate the advantage of the proposed method at low bitrates. The visualization results are shown in FIG. 11, where the first column shows the ground truths. The second column is structure maps extracted via the RCF edge detector [25]. The third column shows the reconstructions of the structure layer, and the images in the last column are reconstructed via VTM. It can be observed that there are serious artifacts in the reconstruction images of VTM, including blocking, ringing, and blurring artifacts in such low bitrate coding scenarios. The values under each image are bpp and DISTS values, where lower DISTS values indicate better quality. As such, the framework can directly transmit the latent codes that reflect the texture information of raw images. Consequently, the proposed compression approach achieves perceptually attractive decoded results based on the semantic texture and the structure maps, even with significantly lower bandwidths when compared to traditional image compression schemes.

To further explore the effectiveness of the structure layer, the ablation study is performed regarding the loss function with [symbol] _{DISTS} and without [symbol] _{DISTS}. The results are shown in Table 2 below, where it can be concluded that the model with [symbol] _{DISTS} could achieve better results on DISTS and LPISP, indicating the generated images have better perceptual consistency.

TABLE 2
The ablation studies of the loss objective in the structure layer

| | bpp | DISTS(↓) | LPSTS(↓) |
|---|---|---|---|
| Ours-Structure layer(w/o [symbol] DISTS) | 0.005 | 0.340 | 0.440 |
| Ours-Structure layer | 0.005 | 0.320 | 0.420 |

The signal layer is responsible for conveying signal-level visual information with enhanced reconstructions. The quantitative results regarding the R-D performance and visualization results are shown in FIGS. 8a-8b and FIG. 12, respectively. The proposed signal layer surpasses JPEG and Ballé et al.'s inferences of LPIPS and DISTS. However, since VVC aims to reconstruct the signals, it may not be able to achieve the same performance when comparing to VTM for signal level reconstruction. FIG. 12 illustrates the decoded images via JPEG, Ballé et al.'s method, VTM, and the proposed method from left to right. The values below each image are bpp and DISTS values, where the lower DISTS values represent the better reconstruction quality. The blocking artifacts and color shift can be clearly observed when using JPEG compression. Moreover, the reconstructed images are blurred when employing Ballé et al.'s method. Regarding VVC, images compressed with VTM exhibit noticeable blocking artifacts in the background regions. By contrast, owing to the cooperation of the structure information, the proposed model provides satisfied visual quality with similar or even smaller coding bits.

In summary, one can see that the SCMC scheme in FIG. 1 therefore transfers visual signals into different modalities for representation. As shown in FIG. 1, the SCMC scheme plays a bridging role between semantic image understanding and image representation, with the three specifically designed layers 24, 26, 28. First, extremely compact representation can be achieved with the semantic layer 24 that encodes semantic information only. Second, between semantic understanding and visual signal reconstruction, in the structure layer 26, geometric structures (e.g., edges and ridges) are extracted, bridging their gap to satisfy diverse demands. Such representation is essentially based upon Marr's Theory on the computational representation framework [28], and lays the foundation for providing a perceptually meaningful representation. Third, the signal-level reconstruction is enabled in the signal layer 28, enhancing the robustness of the proposed compression scheme and providing the faithful reconstruction with sufficient signal-level details.

The proposed SCMC scheme in the embodiment as shown in FIG. 1 enjoys several desired advantages, including compact, flexible and high efficiency. The three layers of representation are designed in the SCMC scheme as described above, following a conceptual organization and coherent design philosophy in the scalable coding framework. An interaction strategy is developed among the three layers, ensuring that the decoding of higher layers is supported by the existence of lower layers. As such, the redundancy among layers can be efficiently removed in the scalable image representation paradigm based upon the solutions in aligning and fusing cross-modality features. The three layers sequentially recover the visual information at semantic, structure and signal levels, and such representation architecture is expected to make profound impacts on a broad range from image processing to image understanding. When only semantic information is required, the proposed framework enables a natural base-layer representation with very compact information conveyed. Moreover, each layer of the scalable stream holds conceptually meaningful information, enhancing the flexibility by decoding the subset layers for a given task and enhancing the interpretability of the bitstream. Finally, the interactions between different layers and fusions of different layers, which are indispensable in scalable representation, ensure the promising rate-distortion performance. Qualitative and quantitative results demonstrate that the proposed SCMC can convey accurate semantic, structure and signal level visual information with diverse configurations, significantly promoting the compression performance.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

Persons skilled in the art may further realize that units and steps of algorithms according to the description of the embodiments disclosed by the present disclosure can be implemented by electronic hardware, computer software, or a combination of the two. To describe interchangeability of hardware and software clearly, compositions and steps of the embodiments are generally described according to functions in the forgoing description. Whether these functions are executed by hardware or software depends upon specific applications and design constraints of the technical solutions. Persons skilled in the art may use different methods for each specific application to implement the described functions, and such implementation should not be construed as a departure from the scope of the present disclosure.

The steps of the methods or algorithms described in the embodiments of the present disclosure may be directly implemented by hardware, software modules executed by the processor, or a combination of both. The software module can be placed in a random access memory (RAM), memory, read only memory (ROM), electrically programmable ROM, electrically erasable and programmable ROM, register, hard disk, mobile disk, CD-ROM, or any other form of storage medium known to the technical domain.

It should be noted that the description of the foregoing embodiments of the electronic device may be like that of the foregoing method embodiments, and the device embodiments have the same beneficial effects as those of the method embodiments. Therefore, details may not be described herein again. For technical details not disclosed in the embodiments of the electronic device of the present disclosure, those skilled in the art may understand according to the method embodiments of the present disclosure.

In the several embodiments provided in the present disclosure, it should be understood that the disclosed device and method may be realized in other manners. The device embodiments described above are merely exemplary. All functional modules or units in the embodiments of the present disclosure may all be integrated in one processing unit, or each unit may be used as a single unit. Two or more units may be integrated in one. The above integrated unit can either be implemented in the form of hardware, or in the form of hardware combined with software functional units.

Persons of ordinary skill in the art should understand that all or a part of steps of implementing the foregoing method embodiments may be implemented by related hardware of a computer instruction program. The instruction program may be stored in a computer-readable storage medium, and when executed, a processor executes the steps of the above method embodiments as stated above. The foregoing storage medium may include various types of storage media, such as a removable storage device, a read only memory (ROM), a random-access memory (RAM), a magnetic disk, or any media that stores program code.

Alternatively, when the above-mentioned integrated units of the present disclosure are implemented in the form of a software functional module being sold or used as an independent product, the integrated unit may also be stored in a computer-readable storage medium. Based on this understanding, the technical solutions provided by the embodiments of the present disclosure essentially or partially may be embodied in the form of a software product stored in a storage medium. The storage medium stores instructions which are executed by a computer device (which may be a personal computer, a server, a network device, or the like) to realize all or a part of the embodiments of the present disclosure. The above-mentioned storage medium may include various media capable of storing program codes, such as a removable storage device, a read only memory (ROM), a random-access memory (RAM), a magnetic disk, or an optical disk.

Logic when implemented in software, can be written in an appropriate language such as but not limited to C # or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

### REFERENCES

Each of the following references (and associated appendices and/or supplements) is expressly incorporated herein by reference in its entirety:
[1] Online; accessed 5 Mar. 2022. VVC software VTM-15.2. https://vcgit.hhi. fraunhofer.de/jvet/VVCSoftware_VTM/-/tree/VTM-15.2
[2] Shuang Bai and Shan An. 2018. A survey on automatic image caption generation. Neurocomputing 311 (2018), 291-304.
[3] Johannes Ballé, Valero Laparra, and Eero P. Simoncelli. 2016. Density Modeling of Images using a Generalized Normalization Transformation. In 4th International Conference on Learning Representations, Yoshua Bengio and Yann LeCun (Eds.).
[4] J Ballé, V Laparra, and E P Simoncelli. 2017. End-to-end optimized image compression. In Int'l Conf on Learning Representations (ICLR).
[5] Johannes Ballé, David Minnen, Saurabh Singh, Sung Jin Hwang, and Nick Johnston. 2018. Variational image compression with a scale hyperprior. arXiv preprint arXiv: 1802.01436 (2018).
[6] Jean Bégaint, Fabien Racapé, Simon Feltman, and Akshay Pushparaja. 2020. CompressAI: a PyTorch library and evaluation platform for end-to-end compression research. arXiv preprint arXiv: 2011.03029 (2020).
[7] Jill M Boyce, Yan Ye, Jianle Chen, and Adarsh K Ramasubramonian. 2015. Overview of SHVC: Scalable extensions of the high efficiency video coding standard. IEEE Transactions on Circuits and Systems for Video Technology 26, 1 (2015), 20-34.
[8] Benjamin Bross, Ye-Kui Wang, Yan Ye, Shan Liu, Jianle Chen, Gary J Sullivan, and Jens-Rainer Ohm. 2021. Overview of the versatile video coding (VVC)
   standard and its applications. IEEE Transactions on Circuits and Systems for Video Technology 31, 10 (2021), 3736-3764.
[9] Jianhui Chang, Qi Mao, Zhenghui Zhao, Shanshe Wang, Shiqi Wang, Hong Zhu, and Siwei Ma. 2019. Layered conceptual image compression via deep semantic synthesis. In 2019 IEEE International Conference on Image Processing (ICIP). IEEE, 694-698.
[10] Jianhui Chang, Zhenghui Zhao, Chuanmin Jia, Shiqi Wang, Lingbo Yang, Jian Zhang, and Siwei Ma. 2020. Conceptual compression via deep structure and texture synthesis. arXiv preprint arXiv: 2011.04976 (2020).
[11] Wengling Chen and James Hays. 2018. SketchyGAN: Towards Diverse and Realistic Sketch to Image Synthesis. In Proceedings of the IEEE Conference on Computer Vision and Pattern Recognition (CVPR).
[12] Zhibo Chen and Tianyu He. 2019. Learning based facial image compression with semantic fidelity metric. Neurocomputing 338 (2019), 16-25.
[13] Keyan Ding, Kede Ma, Shiqi Wang, and Eero Simoncelli. 2020. Image Quality Assessment: Unifying Structure and Texture Similarity. IEEE Transactions on Pattern Analysis and Machine Intelligence PP (12 2020), 1-1.
[14] Ali Farhadi, Mohsen Hejrati, Mohammad Amin Sadeghi, Peter Young, Cyrus Rashtchian, Julia Hockenmaier, and David Forsyth. 2010. Every picture tells a story: Generating sentences from images. In European conference on computer vision. Springer, 15-29.
[15] Arnab Ghosh, Richard Zhang, Puneet K. Dokania, Oliver Wang, Alexei A. Efros, Philip H. S. Torr, and Eli Shechtman. 2019. Interactive Sketch Fill: Multiclass Sketch-to-Image Translation. In Proceedings of the IEEE/CVF International Conference on Computer Vision (ICCV).
[16] Philipp Helle, Haricharan Lakshman, Mischa Siekmann, Jan Stegemann, Tobias Hinz, Heiko Schwarz, Detlev Marpe, and Thomas Wiegand. 2013. A scalable video coding extension of HEVC. In 2013 Data Compression Conference. IEEE, 201-210.
[17 ] Martin Heusel, Hubert Ramsauer, Thomas Unterthiner, Bernhard Nessler, and Sepp Hochreiter. 2017. Gans trained by a two time-scale update rule converge to a local nash equilibrium. Advances in neural information processing systems 30 (2017).
[18] Yueyu Hu, Wenhan Yang, Zhan Ma, and Jiaying Liu. 2021. Learning end-to-end lossy image compression: A benchmark. IEEE Transactions on Pattern Analysis and Machine Intelligence (2021).
[19] David A Huffman. 1952. A method for the construction of minimum-redundancy codes. Proceedings of the IRE 40, 9 (1952), 1098-1101.
[20] Qicheng Lao, Mohammad Havaei, Ahmad Pesaranghader, Francis Dutil, Lisa Di Jorio, and Thomas Fevens. 2019. Dual Adversarial Inference for Text-to-Image Synthesis. In Proceedings of the IEEE/CVF International Conference on Computer Vision (ICCV).
[21] Jiguo Li, Chuanmin Jia, Xinfeng Zhang, Siwei Ma, and Wen Gao. 2021. Cross Modal Compression: Towards Human-comprehensible Semantic Compression. In Proceedings of the 29th ACM International Conference on Multimedia. 4230-4238.
[22] Yang Li, Shiqi Wang, Xinfeng Zhang, Shanshe Wang, Siwei Ma, and Yue Wang. 2021. Quality Assessment of End-to-End Learned Image Compression: The Benchmark and Objective Measure. In Proceedings of the 29th ACM International Conference on Multimedia. 4297-4305.
[23] Jiang-Jiang Liu, Qibin Hou, Ming-Ming Cheng, Changhu Wang, and Jiashi Feng. 2020. Improving convolutional networks with self-calibrated convolutions. In Proceedings of the IEEE/CVF Conference on Computer Vision and Pattern Recognition. 10096-10105.
[24] Kang Liu, Dong Liu, Li Li, Ning Yan, and Houqiang Li. 2021. Semantics-to-signal scalable image compression with learned revertible representations. International Journal of Computer Vision 129, 9 (2021), 2605-2621.
[25] Yun Liu, Ming-Ming Cheng, Xiaowei Hu, Kai Wang, and Xiang Bai. 2017. Richer convolutional features for edge detection. In Proceedings of the IEEE conference on computer vision and pattern recognition. 3000-3009.
[26] Siwei Ma, Xinfeng Zhang, Chuanmin Jia, Zhenghui Zhao, Shiqi Wang, and Shanshe Wang. 2019. Image and video compression with neural networks: A review. IEEE Transactions on Circuits and Systems for Video Technology 30, 6 (2019), 1683-1698.
[27] Xudong Mao, Qing Li, Haoran Xie, Raymond YK Lau, Zhen Wang, and Stephen Paul Smolley. 2017. Least squares generative adversarial networks. In Proceedings of the IEEE international conference on computer vision. 2794-2802.
[28] David Marr. 2010. Vision: A computational investigation into the human representation and processing of visual information. MIT press.
[29] Fabian Mentzer, George D Toderici, Michael Tschannen, and Eirikur Agustsson. 2020. High-fidelity generative image compression. Advances in Neural Information Processing Systems 33 (2020), 11913-11924.
[30] Taesung Park, Ming-Yu Liu, Ting-Chun Wang, and Jun-Yan Zhu. 2019. Semantic image synthesis with spatially-adaptive normalization. In Proceedings of the IEEE/CVF conference on computer vision and pattern recognition. 2337-2346.
[31] Majid Rabbani and Raj an Joshi. 2002. An overview of the JPEG 2000 still image compression standard. Signal processing: Image communication 17, 1 (2002), 3-48.
[32] Scott Reed, Zeynep Akata, Xinchen Yan, Lajanugen Logeswaran, Bernt Schiele, and Honglak Lee. 2016. Generative adversarial text to image synthesis. In International conference on machine learning. PMLR, 1060-1069.
[33] Tim Salimans, Ian Goodfellow, Wojciech Zaremba, Vicki Cheung, Alec Radford, and Xi Chen. 2016. Improved techniques for training gans. Advances in neural information processing systems 29 (2016).
[34] Heiko Schwarz, Detlev Marpe, and Thomas Wiegand. 2007. Overview of the scalable video coding extension of the H.264/AVC standard. IEEE Transactions on circuits and systems for video technology 17, 9 (2007), 1103-1120.
[35] C Andrew Segall and Gary J Sullivan. 2007. Spatial scalability within the H. 264/AVC scalable video coding extension. IEEE Transactions on Circuits and Systems for Video Technology 17, 9 (2007), 1121-1135.
[36] Wenzhe Shi, Jose Caballero, Ferenc Huszár, Johannes Totz, Andrew P Aitken, Rob Bishop, Daniel Rueckert, and Zehan Wang. 2016. Real-time single image and video super-resolution using an efficient sub-pixel convolutional neural network. In Proceedings of the IEEE conference on computer vision and pattern recognition. 1874-1883.
[37] Gary J Sullivan, Jens-Rainer Ohm, Woo-Jin Han, and Thomas Wiegand. 2012. Overview of the high efficiency video coding (HEVC) standard. IEEE Transactions on circuits and systems for video technology 22, 12 (2012), 1649-1668.
[38] Simeng Sun, Tianyu He, and Zhibo Chen. 2020. Semantic structured image coding framework for multiple intelligent applications. IEEE Transactions on Circuits and Systems for Video Technology 31, 9 (2020), 3631-3642.
[39] George Toderici, Sean M. O'Malley, Sung Jin Hwang, Damien Vincent, David Minnen, Shumeet Baluja, Michele Covell, and Rahul Sukthankar. 2016. Variable Rate Image Compression with Recurrent Neural Networks. In 4th International Conference on Learning Representations, ICLR 2016, San Juan, Puerto Rico, May 2-4, 2016, Conference Track Proceedings, Yoshua Bengio and Yann LeCun (Eds.).
[40] George Toderici, Damien Vincent, Nick Johnston, Sung Jin Hwang, David Minnen, Joel Shor, and Michele Covell. 2017. Full resolution image compression with recurrent neural networks. In Proceedings of the IEEE conference on Computer Vision and Pattern Recognition. 5306-5314.
[41] Hanyue Tu, Li Li, Wengang Zhou, and Houqiang Li. 2021. Semantic Scalable Image Compression with Cross-Layer Priors. In Proceedings of the 29th ACM International Conference on Multimedia. 4044-4052.
[42] Ashish Vaswani, Noam Shazeer, Niki Parmar, Jakob Uszkoreit, Llion Jones, Aidan N Gomez, Łukasz Kaiser, and Illia Polosukhin. 2017. Attention is all you need. Advances in neural information processing systems 30 (2017).
[43] Oriol Vinyals, Alexander Toshev, Samy Bengio, and Dumitru Erhan. 2015. Show and tell: A neural image caption generator. In Proceedings of the IEEE conference on computer vision and pattern recognition. 3156-3164.
[44] Oriol Vinyals, Alexander Toshev, Samy Bengio, and Dumitru Erhan. 2016. Show and tell: Lessons learned from the 2015 mscoco image captioning challenge. IEEE transactions on pattern analysis and machine intelligence 39, 4 (2016), 652-663.
[45] Catherine Wah, Steve Branson, Peter Welinder, Pietro Perona, and Serge Belongie. 2011. The caltech-ucsd birds-200-2011 dataset. (2011).
[46] Gregory K Wallace. 1992. The JPEG still picture compression standard. IEEE transactions on consumer electronics 38, 1 (1992), xviii-xxxiv.
[47] Shurun Wang, Shiqi Wang, Wenhan Yang, Xinfeng Zhang, Shanshe Wang, Siwei Ma, and Wen Gao. 2021. Towards analysis-friendly face representation with scalable feature and texture compression. IEEE Transactions on Multimedia (2021).
[48] Yao Wang, Jörn Ostermann, and Ya-Qin Zhang. 2002. Video processing and communications. Prentice Hall.
[49] Kelvin Xu, Jimmy Ba, Ryan Kiros, Kyunghyun Cho, Aaron Courville, Ruslan Salakhudinov, Rich Zemel, and Yoshua Bengio. 2015. Show, attend and tell: Neural image caption generation with visual attention. In International conference on machine learning. PMLR, 2048-2057.
[50] Tao Xu, Pengchuan Zhang, Qiuyuan Huang, Han Zhang, Zhe Gan, Xiaolei Huang, and Xiaodong He. 2018. Attngan: Fine-grained text to image generation with attentional generative adversarial networks. In Proceedings of the IEEE conference on computer vision and pattern recognition. 1316-1324.
[51] Shuai Yang, Yueyu Hu, Wenhan Yang, Ling-Yu Duan, and haying Liu. 2021. Towards coding for human and machine vision: Scalable face image coding. IEEE Transactions on Multimedia 23 (2021), 2957-2971.
[52] Yezhou Yang, Ching Teo, Hal Daumé III, and Yiannis Aloimonos. 2011. Corpusguided sentence generation of natural images. In Proceedings of the 2011 Conference on Empirical Methods in Natural Language Processing. 444-454.
[53] Yan Ye and Pierre Andrivon. 2014. The scalable extensions of HEVC for ultrahigh-definition video delivery. IEEE MultiMedia 21, 3 (2014), 58-64.
[54] Richard Zhang, Phillip Isola, Alexei A Efros, Eli Shechtman, and Oliver Wang. 2018. The unreasonable effectiveness of deep features as a perceptual metric. In Proceedings of the IEEE conference on computer vision and pattern recognition. 586-595.
[55] Zhizheng Zhang, Zhibo Chen, Jianxin Lin, and Weiping Li. 2019. Learned scalable image compression with bidirectional context disentanglement network. In 2019 IEEE International Conference on Multimedia and Expo (ICME). IEEE, 1438-1443.
[56] Weijia Zhu, Wenpeng Ding, Jizheng Xu, Yunhui Shi, and Baocai Yin. 2014. Screen content coding based on HEVC framework. IEEE Transactions on Multimedia 16, 5 (2014), 1316-1326.

What is claimed is:

1. A computer-implemented method for scalable compression of a digital image, comprising the steps of:
a) extracting from the image semantic information at a semantic layer;
b) extracting from the image structure information at a structure layer;
c) extracting from the image signal information at a signal layer; and
d) compressing each one of the semantic information, the structure information, and the signal information into a bitstream.

2. The method of claim 1, wherein the semantic information is included in a text caption; Step a) further comprising the step of generating the text caption of the image using image-to-text translation.

3. The method of claim 2, wherein the step of generating the text caption further comprises the steps of translating the image into compact representations using a convolutional neural network (CNN), and using a recurrent neural network to generate the text caption from the compact representations.

4. The method of claim 2, wherein Step d) further comprises the step of conducting a lossless compression of the text caption.

5. The method of claim 1, wherein Step d) further comprises the step of compressing the signal information using a learning-based codec.

6. The method of claim 1, wherein the structure information comprises a structure map; Step b) further comprising the step of obtaining the structure map using Richer Convolutional Features (RCF) structure extraction.

7. A computer-implemented method for reconstructing a digital image from multiple bitstreams including a semantic stream, a structure stream, and a signal stream; the method comprising the steps of:
a) decoding, from the semantic stream, semantic information of the digital image;
b) decoding, from the structure stream, structure information of the digital image;
c) combining the structure information and the semantic information to obtain a perceptual reconstruction of the image;
d) decoding, from the signal stream, signal information of the digital image; and
e) reconstructing the image using the signal information based on the perceptual reconstruction.

8. The method of claim 7, wherein the semantic information is included in a text caption; Step a) further comprising the step of generating a semantic image from the text caption.

9. The method of claim 7, wherein the semantic information comprises a semantic texture map which is adapted to be used to extract semantic features; the structure information comprising a structure map which is adapted to be used to extract structures.

10. The method of claim 9, wherein Step c) further comprises the steps of:
f) aligning semantic features derived from the semantic texture map, and structure features derived from the structure map; and
g) fusing the aligned structure and semantic features.

11. The method of claim 10, wherein Step f) further comprises the steps of:
h) converting the structure map and the semantic texture map into feature domains; and
i) aligning the structure and semantic features using a multi-scale alignment strategy.

12. The method of claim 10, wherein Step g) further comprises the steps of conducting self-calibrated convolution separately to the aligned structures and semantic features; and merging the aligned structure and semantic features via element-wise addition.

13. The method of claim 9, wherein Step e) further comprises the steps of:
j) generating multi-scale structure features from the structure map and the perceptual reconstruction; and
k) fusing the multi-scale structure features with the signal features to reconstruct the image.

14. A system for scalable compression of a digital image, the system comprising a non-transitory computer-readable medium with instructions stored thereon, that when executed by a processor, cause the processor to perform the method as recited in claim 1.

15. A system for scalable compression of a digital image, the system comprising a non-transitory computer-readable medium with instructions stored thereon, that when executed by a processor, cause the processor to perform the method as recited in claim 7.
